(19) United States
(12) Patent Application Publication
(10) Pub. No.: US 2022/0201491 A1
(43) Pub. Date: Jun. 23, 2022

(54) PAIRING METHOD AND DEVICE

(71) Applicant: HUAWEI TECHNOLOGIES CO., LTD., Shenzhen (CN)

(72) Inventors: Zhao JIN, Beijing (CN); Lu ZHAO, Shanghai (CN); Guangyao NIE, Hangzhou (CN)

(73) Assignee: HUAWEI TECHNOLOGIES CO., LTD., Shenzhen (CN)

(21) Appl. No.: 17/692,448

(22) Filed: Mar. 11, 2022

Related U.S. Application Data
(63) Continuation of application No. PCT/CN2020/100455, filed on Jul. 6, 2020.

(30) Foreign Application Priority Data
Sep. 18, 2019 (CN) 201910883635.3

(51) Int. Cl. H04W 12/50; H04W 76/14; H04W 8/00; H04W 12/06; H04W 12/037

(52) U.S. Cl. CPC H04W 12/50; H04W 76/14; H04W 84/18; H04W 12/06; H04W 12/037; H04W 8/005

(57) ABSTRACT

A pairing method and a device. The method is applied to first user equipment, and the first user equipment belongs to a cluster including at least two pieces of user equipment. Each piece of user equipment in the cluster stores first information, and the first information includes a pairing credential and identification information of a first accessory device that has been successfully paired with any piece of user equipment in the cluster. The method includes: detecting a second accessory device, where the second accessory device is an accessory device that has not been successfully paired with any piece of user equipment in the cluster; and pairing with and establishing a connection to the second accessory device based on the pairing credential and synchronizing identification information of the second accessory device to all user equipment in the cluster.

### CROSS-REFERENCE TO RELATED APPLICATIONS

This application is a continuation of International Patent Application No. PCT/CN2020/100455, filed on Jul. 6, 2020, which claims priority to Chinese Patent Application No. 201910883635.3, filed on Sep. 18, 2019. The disclosures of the aforementioned applications are hereby incorporated by reference in their entireties.

### TECHNICAL FIELD

Embodiments relate to the communication field, and in particular, to a pairing method and a device.

### BACKGROUND

With the development of internet of things technologies, solutions for cooperation between different internet of things devices are continuously emerging and are widely used in the industrial community and the academic community.

Currently, a relatively common solution for cooperation between internet of things devices usually requires pairwise pairing negotiation between the devices, to implement connection and access between a plurality of devices.

In an existing technology, when an internet of things device is used as an accessory device and desires to be paired with a plurality of pieces of other user equipment at the same time, and is used through direct switching between the plurality of pieces of user equipment, the user equipment usually needs to upload pairing information to a cloud server, and then the cloud server delivers the pairing information to other user equipment, so that switching between a plurality of internet of things devices and a plurality of accessory devices for use can be implemented, and pairing negotiation does not need to be performed.

FIG. 1 is a schematic flowchart of using a cloud pairing method in the existing technology. An accessory device may perform pairing with and establishes a connection to user equipment 1. An accessory device may send a pairing credential (namely, pairing information) generated through negotiation between the two parties to a cloud service, and the cloud service forwards the pairing credential to user equipment 2 and user equipment 3. In this way, when the accessory device is connected to the user equipment 2 and/or the user equipment 3, because both the two parties have the pairing credential, a connection between the two parties can be established without pairing.

In summary, the existing technology relies on cloud to perform an encryption, caching, and issuing process on the pairing credential. However, the cloud service may have use and security risks such as being inaccessible or unreliable. Once the cloud service is unavailable, or behavior such as malicious monitoring or tampering exists, this solution poses risks to a user of a device.

### SUMMARY

A pairing method and a device may improve t security and reliability in a pairing process.

To achieve the foregoing objectives, the following solutions are used.

According to a first aspect, an embodiment provides a pairing method. The method may be applied to first user equipment, and the first user equipment belongs to a cluster including at least two pieces of user equipment. Each piece of user equipment in the cluster stores first information, and the first information includes a pairing credential and identification information of a first accessory device that has been successfully paired with any piece of user equipment in the cluster. In other words, the first user equipment has joined the cluster before pairing, and the first user equipment locally stores shared information (namely, the first information) in the cluster. The pairing credential included in the first information is used for pairing the user equipment in the cluster with an accessory device. The first information further includes the identification information of the first accessory device that has been successfully paired with any piece of user equipment in the cluster. The identification information may be used by a device in the cluster to identify, based on the identification information, whether an accessory device to be paired with is the first accessory device, or whether an accessory device to be paired with has been successfully paired with any piece of user equipment in the cluster. A process of pairing the first user equipment with an accessory device (for example, a second accessory device) that has not been successfully paired with any piece of user equipment in the cluster is as follows:

After detecting the second accessory device, the first user equipment may be paired with and connected to the second accessory device based on the locally stored pairing credential. Then, the first user equipment may synchronize identification information of the second accessory device to all user equipment in the cluster, so that when detecting the second accessory device, the user equipment in the cluster may determine, based on a locally stored identifier of the second accessory device, that the second accessory device has been successfully paired with the user equipment in the cluster. In this case, the user equipment in the cluster may directly establish a connection to the second accessory device based on pairing information without a pairing process.

A distributed storage manner may be implemented by storing the pairing credential and identifiers of successfully paired accessory devices such as the first accessory device and the second accessory device in each piece of user equipment in the cluster. Based on a decentralization feature of distributed storage, a plurality of pieces of user equipment can share data (for example, the first information) in the cluster. Therefore, transfer and switching of the pairing credential between the user equipment and the accessory device may no longer depend on a cloud service, and the transferred pairing credential is visible only to user equipment in the cluster, so that a problem of a potential risk of a cloud server center is resolved.

In a possible implementation, the cluster may be a blockchain network, and the user equipment may be referred to as a node on a blockchain. Each piece of user equipment in the blockchain network stores a blockchain, and a block on the blockchain stores the pairing credential and the identification information of the first accessory device. Optionally, a manner in which the first user equipment synchronizes the identification information of the second accessory device to all user equipment in the cluster may include: The first user equipment generates a new block including the identification information of the second accessory device, and adds the new block to a blockchain on the first user equipment, and then, the first user equipment synchronizes the new block to a blockchain on another piece of user equipment in the blockchain network.

In the foregoing manner, information such as the pairing information may be stored on each node in the blockchain network by using the blockchain, so that security of the pairing process is further improved through decentralization of the blockchain and a tamper-resistant feature of the block.

In a possible implementation, the pairing credential is generated after an original pairing credential is encrypted based on encryption information of the first user equipment. The original pairing credential is generated by user equipment that establishes the blockchain network, or the original pairing credential is generated by any piece of user equipment in the blockchain network.

The original pairing credential may be encrypted based on encryption information of the user equipment, so that only a device holding the encryption information of the user equipment can decrypt the pairing credential and obtain the original pairing credential. Therefore, security is effectively improved, and a risk that the original pairing credential may be tampered with when the original pairing credential is stored through cloud storage is avoided.

In a possible implementation, the pairing with and establishing a connection to the second accessory device based on the pairing credential includes: obtaining the pairing credential from the blockchain on the first user equipment; decrypting the pairing credential based on decryption information of the first user equipment, to obtain the original pairing credential; and sending the original pairing credential to the second accessory device, determining, after a pairing response message of the second accessory device is received, that pairing with the second accessory device succeeds, and establishing the connection to the second accessory device.

The original pairing credential may be encrypted in advance, and is then stored in the blockchain, so that each node (or user equipment) in the blockchain network may obtain, from the blockchain during pairing, a pairing credential encrypted by using encryption information of the user equipment and decrypt the pairing credential to obtain the original pairing credential. Therefore, security of the pairing process is further improved.

In a possible implementation, the encryption information of the first user equipment and the decryption information of the first user equipment are different.

The encryption information and the decryption information may be an encryption/decryption pair; in other words, the original pairing credential that is encrypted by using the encryption information may be decrypted by using the decryption information. That the encryption information and the decryption information are different may be understood as that asymmetric algorithms are used for keys including the encryption information and the decryption information. Optionally, the encryption information may be a public key, and the decryption information may be a private key.

In a possible implementation, the block on the blockchain further stores encryption information of the first accessory device. The synchronizing the identification information of the second accessory device to all user equipment in the cluster includes: generating a new block including the identification information of the second accessory device and encryption information of the second accessory device and adding the new block to the blockchain on the first user equipment; and synchronizing the new block to a blockchain on another piece of user equipment in the blockchain network.

In the foregoing manner, after being successfully paired with an accessory device, the user equipment stores an identifier and encryption information of the accessory device on the block, so that another piece of user equipment in the blockchain network may identify, based on the identifier, whether the accessory device has been successfully paired with the user equipment in the blockchain network, and when it is identified that the accessory device is an accessory device that has been successfully paired with any piece of user equipment, the encryption information that is stored on the blockchain and that corresponds to the identifier of the accessory device is obtained, and a connection is directly established to the accessory device based on the encryption information and the original pairing credential.

According to a second aspect, an embodiment provides a pairing apparatus. The pairing apparatus may be applied to first user equipment, and the first user equipment belongs to a cluster including at least two pieces of user equipment. Each piece of user equipment in the cluster stores first information, and the first information includes a pairing credential and identification information of a first accessory device that has been successfully paired with any piece of user equipment in the cluster. The apparatus includes a memory and a processor, and the memory is coupled to the processor. The memory stores program instructions. When the program instructions are run by the processor, the apparatus is enabled to perform the following steps: detecting a second accessory device, where the second accessory device is an accessory device that has not been successfully paired with any piece of user equipment in the cluster; and establishing a connection to the second accessory device based on the pairing credential, and synchronizing identification information of the second accessory device to all user equipment in the cluster.

In a possible implementation, the cluster is a blockchain network. Each piece of user equipment in the blockchain network stores a blockchain, and a block on the blockchain stores the pairing credential and the identification information of the first accessory device. When the program instructions are run by the processor, the apparatus is enabled to perform the following steps: generating a new block that includes identification information of the second accessory device, adding the new block to a blockchain on the first user equipment, and synchronizing the new block to a blockchain on another piece of user equipment in the blockchain network.

In a possible implementation, the pairing credential is generated after an original pairing credential is encrypted based on encryption information of the first user equipment. The original pairing credential is generated by user equipment that establishes the blockchain network, or the original pairing credential is generated by any piece of user equipment in the blockchain network.

In a possible implementation, when the program instructions are run by the processor, the apparatus is enabled to perform the following steps: obtaining the pairing credential from the blockchain on the first user equipment; decrypting the pairing credential based on decryption information of the first user equipment, to obtain the original pairing credential; and sending the original pairing credential to the second accessory device, determining, after a pairing response message of the second accessory device is received, that pairing with the second accessory device succeeds, and establishing the connection to the second accessory device.

In a possible implementation, the encryption information of the first user equipment and the decryption information of the first user equipment are different.

In a possible implementation, the block on the blockchain further stores encryption information of the first accessory device. When the program instructions are run by the processor, the apparatus is enabled to perform the following steps: generating a new block including the identification information of the second accessory device and encryption information of the second accessory device, and adding the new block to the blockchain on the first user equipment; and synchronizing the new block to a blockchain on another piece of user equipment in the blockchain network.

According to a third aspect, an embodiment provides user equipment. The user equipment belongs to a cluster including at least two pieces of user equipment. Each piece of user equipment in the cluster stores first information, and the first information includes a pairing credential and identification information of a first accessory device that has been successfully paired with any piece of user equipment in the cluster. The user equipment may include a detection module, a pairing and connection module, and a blockchain module. The detection module is configured to detect a second accessory device, where the second accessory device is an accessory device that has not been successfully paired with any piece of user equipment in the cluster. The pairing and connection module is configured to be paired with and establish a connection to the second accessory device based on the pairing credential. The blockchain module is configured to synchronize identification information of the second accessory device to all user equipment in the cluster.

In a possible implementation, the cluster is a blockchain network. Each piece of user equipment in the blockchain network stores a blockchain, and a block on the blockchain stores the pairing credential and the identification information of the first accessory device. The blockchain module may be configured to: generate a new block including identification information of the second accessory device and add the new block to a blockchain on the first user equipment; and synchronize the new block to a blockchain on another piece of user equipment in the blockchain network.

In a possible implementation, the pairing credential is generated after an original pairing credential is encrypted based on encryption information of the first user equipment. The original pairing credential is generated by user equipment that establishes the blockchain network, or the original pairing credential is generated by any piece of user equipment in the blockchain network.

In a possible implementation, the pairing and connection module may be further configured to: obtain the pairing credential from the blockchain on the first user equipment; decrypt the pairing credential based on decryption information of the first user equipment, to obtain the original pairing credential; and send the original pairing credential to the second accessory device, determine, after a pairing response message of the second accessory device is received, that pairing with the second accessory device succeeds, and establish the connection to the second accessory device.

In a possible implementation, the encryption information of the first user equipment and the decryption information of the first user equipment are different.

In a possible implementation, the block on the blockchain further stores encryption information of the first accessory device. The blockchain module may be further configured to: generate a new block including the identification information of the second accessory device and encryption information of the second accessory device and add the new block to the blockchain on the first user equipment; and synchronize the new block to a blockchain on another piece of user equipment in the blockchain network.

According to a fourth aspect, an embodiment provides a system. The system includes first user equipment, second user equipment, a first accessory, and a second accessory. The first user equipment and the second user equipment belong to a cluster including at least two pieces of user equipment. Each piece of user equipment in the cluster stores first information, and the first information includes a pairing credential of the first user equipment, a pairing credential of the second user equipment, and identification information of a first accessory device that has been successfully paired with any piece of user equipment in the cluster.

The first user equipment is configured to: detect a second accessory device, where the second accessory device is an accessory device that has not been successfully paired with any piece of user equipment in the cluster; and pair with and establish a connection to the second accessory device based on the pairing credential of the first user equipment, and synchronize identification information of the second accessory device to all user equipment in the cluster.

The second user equipment is configured to: receive and store the identification information of the second accessory device; and detect the second accessory device, determine, based on the identification information of the second accessory device, that the second accessory device is an accessory device that has been successfully paired with any piece of user equipment in the cluster, and then establish a connection to the second accessory device based on the pairing credential of the second user equipment.

According to a fifth aspect, an embodiment provides a non-transitory computer-readable medium, configured to store a computer program. The computer program includes instructions used to perform the method according to any one of the first aspect or the possible implementations of the first aspect.

According to a sixth aspect, an embodiment provides a computer program. The computer program includes instructions used to perform the method according to any one of the first aspect or the possible implementations of the first aspect.

According to a seventh aspect, an embodiment provides a chip. The chip includes a processing circuit and a transceiver pin. The transceiver pin and the processing circuit communicate with each other by using an internal connection path. The processing circuit performs the method according to any one of the first aspect or the possible implementations of the first aspect, to control a receive pin to receive a signal and a transmit pin to send a signal.

### BRIEF DESCRIPTION OF DRAWINGS

To describe the solutions in the embodiments more clearly, the following briefly describes the accompanying drawings for describing the embodiments o. The accompanying drawings in the following description show merely some embodiments, and a person of ordinary skill in the art may derive other drawings from these accompanying drawings without creative efforts.

FIG. 1 is a schematic flowchart of a pairing method in the existing technology;

FIG. 2 is a schematic diagram of an application scenario according to an embodiment;

FIG. 3 is a flowchart of a pairing method according to an embodiment;

FIG. 4 is a flowchart of a pairing method according to an embodiment;

FIG. 5 is a flowchart of a data transfer process in a blockchain according to an embodiment;

FIG. 6A and FIG. 6B are a flowchart of a pairing method in an example;

FIG. 7 is a schematic diagram of an operation in an example;

FIG. 8 is a schematic diagram of an operation in an example;

FIG. 9 is a flowchart of a pairing method according to an embodiment;

FIG. 10 is a flowchart of a data transfer process in a blockchain according to an embodiment;

FIG. 11A and FIG. 11B are a flowchart of a pairing method in an example;

FIG. 12 is a schematic diagram of a structure of user equipment according to an embodiment; and

FIG. 13 is a schematic block diagram of user equipment according to an embodiment.

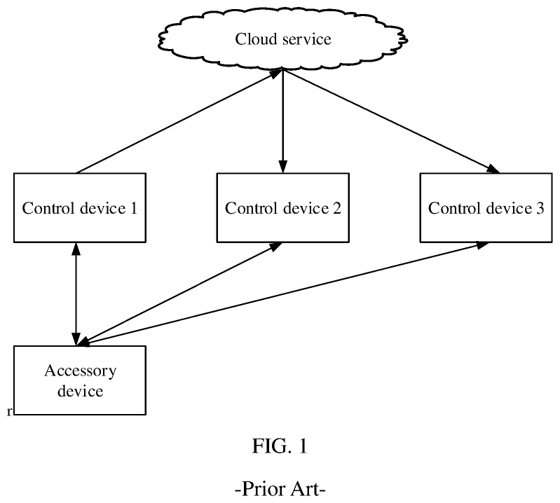

### DETAILED DESCRIPTION OF THE EMBODIMENTS

The following describes the solutions in the embodiments with reference to the accompanying drawings. It should be understood that the described embodiments are some, but not all, of the embodiments. All other embodiments obtained by a person of ordinary skill in the art based on the embodiments without creative efforts shall fall within the protection scope.

The term “and/or” describes only an association relationship for associated objects and represents that three relationships may exist. For example, A and/or B may represent the following three cases: only A exists, both A and B exist, and only B exists.

In the embodiments, the terms “first”, “second”, and the like are intended to distinguish between different objects but do not indicate a particular order of the objects. For example, a first target object, a second target object, and the like are intended to distinguish between different target objects but do not indicate a particular order of the target objects.

In the embodiments, the word “example” or “for example” is used to represent giving an example, an illustration, or a description. Any embodiment described as an “example” or “for example” in the embodiments should not be explained as being more preferred or having more advantages than another embodiment. Use of the terms such as “example” or “for example” is intended to present a related concept.

In the embodiments, unless otherwise stated, “a plurality of” means two or more than two. For example, a plurality of processing units are two or more processing units. A plurality of systems are two or more systems.

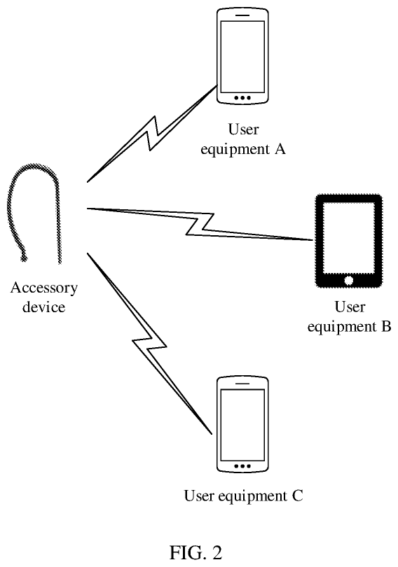

Before the solutions in the embodiments are described, an application scenario of the embodiments is first described with reference to the accompanying drawings. FIG. 2 is a schematic diagram of an application scenario according to an embodiment. This application scenario includes user equipment A, user equipment B, user equipment C, and an accessory device A. In this embodiment, user equipment (for example, the user equipment A, the user equipment B, and/or the user equipment C) may be a wireless communication device such as a mobile phone, a tablet computer, a notebook computer, a desktop computer, a vehicle-mounted computer, a television set, or a virtual reality (VR) device. This type of device may be paired with an accessory device and may establish and use a connection after pairing succeeds. The accessory device is a wireless device such as a headset, a watch, a keyboard, a mouse, or VR glasses, or may be another internet of things (IoT) device that can be connected to the foregoing user equipment and be used after pairing, such as a speaker, a desk lamp, a television set, a refrigerator, an air conditioner, a washing machine, a water heater, an electric cooker, or a microwave oven. It should be noted that, in actual application, both a quantity of user equipment and a quantity of accessory devices may be one or more. A quantity of user equipment and a quantity of accessory devices in the application scenario shown in FIG. 2 are merely adaptive examples.

An implementation solution is described below with reference to the schematic diagram of the application scenario shown in FIG. 2.

Scenario 1

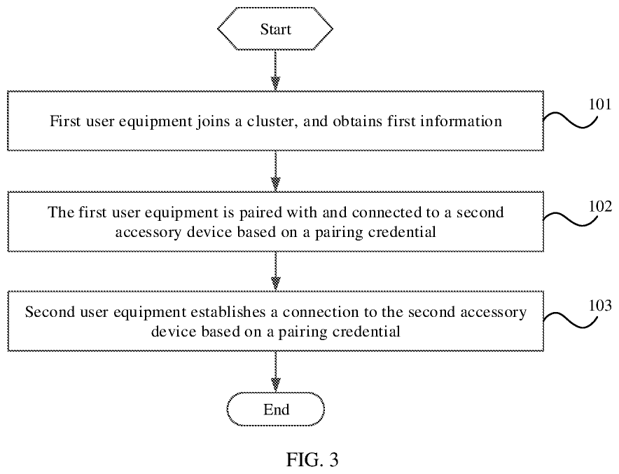

With reference to FIG. 2, FIG. 3 is a schematic flowchart of a pairing method according to an embodiment. In FIG. 3:

Step 101: First user equipment joins a cluster and obtains first information.

The first user equipment may join the cluster before pairing. Each piece of user equipment in the cluster stores first information, and the first information may also be referred to as shared information. The first information includes but is not limited to a pairing credential and identification information of an accessory device that has been successfully paired with any piece of user equipment in the cluster. For example, the first information may include identification information of a first accessory device that has been successfully paired with the user equipment in the cluster. A manner for establishing the cluster is described in detail in the following embodiments. Optionally, the pairing credential is generated after an original pairing credential is encrypted based on encryption information of the first user equipment, and a process of generating the original pairing credential and the pairing credential is described in the following embodiments.

In an example, the first user equipment may send a join request to any user equipment in the cluster, to join the cluster. In another example, any piece of user equipment in the cluster may send a join invitation to the first user equipment, to invite the first user equipment to join the cluster. In still another example, the first user equipment may alternatively be an initiator of the cluster.

Optionally, after joining the cluster, the first user equipment may obtain the first information, and locally store the first information.

Step 102: The first user equipment is paired with and connected to a second accessory device based on the pairing credential.

The first user equipment may obtain identification information of the second accessory device after detecting the second accessory device. The first user equipment may determine, by retrieving the first information, that the identification information of the second accessory device is not in the first information; in other words, the second accessory device has not been successfully paired with any user equipment in the cluster.

Subsequently, the first user equipment may locally obtain the pairing credential and obtain the original pairing credential after decrypting the pairing credential (a decryption process is described in the following embodiments). Then, the first user equipment may pair with and establish a connection to the second accessory device based on the original pairing credential. In a pairing process, the first user equipment sends the original pairing credential to the second accessory device, and the second accessory device locally stores the original pairing credential. A pairing and connection process is described in detail in the following embodiments.

In addition, after the pairing succeeds, the first user equipment locally stores the identification information of the second accessory device and synchronizes the identification information of the second accessory device to all user equipment in the cluster. After receiving the identification information of the second accessory device, each piece of user equipment in the cluster locally stores the identification information. For example, after receiving the identification information of the second accessory device, second user equipment that is already in the cluster locally stores the identification information. In other words, the user equipment (including the first user equipment, the second user equipment, and the like) in the cluster locally stores the pairing credential of the first user equipment, the identification information of the first accessory device, and the identification information of the second accessory device.

Step 103: The second user equipment establishes a connection to the second accessory device based on a pairing credential.

The second user equipment in the cluster may be used as an example, and the second user equipment may be any device in the cluster. Optionally, the first information may further include the pairing credential of the second user equipment, and the pairing credential is generated after an original credential is encrypted based on encryption information of the second user equipment.

The second user equipment detects the second accessory device and obtains the identification information of the second accessory device. If the second user equipment determines, by detecting locally stored information, that the identification information of the second accessory device is already in local storage, the second user equipment may determine that the second accessory device has been successfully paired with the user equipment in the cluster. Then, the second user equipment may obtain an original pairing credential in the second accessory device (to be distinguished from the original pairing credential stored in the user equipment in the cluster, in the following descriptions, the original pairing credential stored in the second accessory device is referred to as a to-be-verified original pairing credential), and the second user equipment locally obtains the original pairing credential; in other words, the second user equipment obtains the pairing credential of the second user equipment from the first information, and obtains the original pairing credential after decrypting the pairing credential. The second user equipment compares the to-be-verified original pairing credential with the locally stored original pairing credential, to verify authenticity of an accessory device corresponding to the identification information. In other words, there may be a pseudo-accessory device. The pseudo-accessory device may disguise as the second accessory device, and the pseudo-accessory device may have the identification information of the second accessory device, but the pseudo-accessory device cannot obtain the original pairing credential stored in the second accessory device. To avoid intrusion of a pseudo device, the to-be-verified original pairing credential is compared with the original pairing credential, so that it may be further determined whether the accessory device is actually a second accessory device that has been successfully paired with the user equipment in the cluster.

Optionally, if a comparison result is that the to-be-verified original pairing credential and the original pairing credential are consistent, the second user equipment may directly establish the connection to the second accessory device.

In a possible implementation, the step in which the user equipment joins the cluster is performed before the user equipment pairs with or establishes the connection to the accessory device. In an example, the user equipment may join the cluster in a cluster establishment process. In another example, the user equipment may join the cluster before the user equipment needs to be paired with or connected to the accessory device.

In a possible implementation, after the cluster is successfully established, if another piece of user equipment needs to join the cluster, in an example, any node in the cluster may send a join invitation to the user equipment that needs to join the cluster. In another example, the user equipment that needs to join the cluster may send a join request to any node in the cluster.

In a possible implementation, in a cluster establishment phase, user equipment (primary user equipment for short) used as an initiator, such as user equipment A, may send a join invitation to each piece of user equipment (such as user equipment B and user equipment C) that can perform communication in a network, to add all user equipment in the network that can communicate with the user equipment A to the cluster in the cluster establishment phase. For example, a home scenario includes at least one mobile phone, at least one tablet computer, and at least one computer, and a user may set a mobile phone A as primary user equipment. The mobile phone A may send join invitations to other devices in the home scenario, including at least one mobile phone, at least one tablet computer, and at least one computer. If a join response from each device is received, the mobile phone A determines that a cluster is to be established with each device that feeds back the response message.

In a possible implementation, the first information may further include but is not limited to an invitation record and/or a node record. The invitation record is used to record an inviting party and an invited party. For example, if the user equipment B joins the cluster with the permission of the user equipment A, the information may be recorded in the first information, to further improve security of a pairing process. The node record may be used to record information such as a member in the cluster and/or a quantity of members.

In a possible implementation, the user equipment in the cluster, for example, the user equipment C, may alternatively be a far-field device; in other words, communication between the user equipment C and the user equipment A and/or the user equipment B may be communication performed by using cloud, so that data in the cluster is shared.

Scenario 2

To make a person skilled in the field better understand the solutions in the embodiments, a blockchain network is used as an example of the cluster below for detailed description.

To facilitate understanding of the solutions, some concepts in a blockchain network architecture are first described.

Client: A user may implement, by using a client in a blockchain system, functions such as creating a chaincode and initiating a transaction. The client may be deployed on any terminal and is implemented by using a corresponding SDK (software development kit) of the blockchain system. The terminal communicates with a node in a blockchain network, so that a corresponding function of the client is implemented.

Block: In a blockchain technology, data is permanently stored in a form of electronic records, and a file storing these electronic records is referred to as a “block”. Blocks are generated one by one in a chronological order. Each block records all value-exchange activities that occur during creation of the block, and all blocks are aggregated to form a chain record set.

Block structure: Transaction data in a time period for generating the block is recorded in the block, and a main body of the block is actually a set of transaction information. Structures of all blockchains may not be completely the same, but a general structure is divided into two parts: a block header (header) and a block body (body). The block header is configured to link to a previous block and provide integrity assurance for a block chain database. The block body includes all records that are verified and that of value exchanges occurring during block creation.

Node (peer): In the blockchain network, a network system having a distributed structure is constructed, so that all data in a database is updated in real time and stored in all network nodes that participate in recording. In addition, the blockchain network constructs an entire set of protocol mechanisms, so that each node in the entire network also verifies, when participate in recording, correctness of a result recorded by another node. Only when the protocol mechanisms enable nodes (for example, all nodes, most nodes, or specific nodes) meeting a condition to all consider a record correct, or after all comparison results of all the nodes participating in recording are passed, authenticity of the record can be recognized in the entire network and recorded data is allowed to be written to the block. Therefore, in the blockchain network, a decentralized distributed database includes all the nodes together.

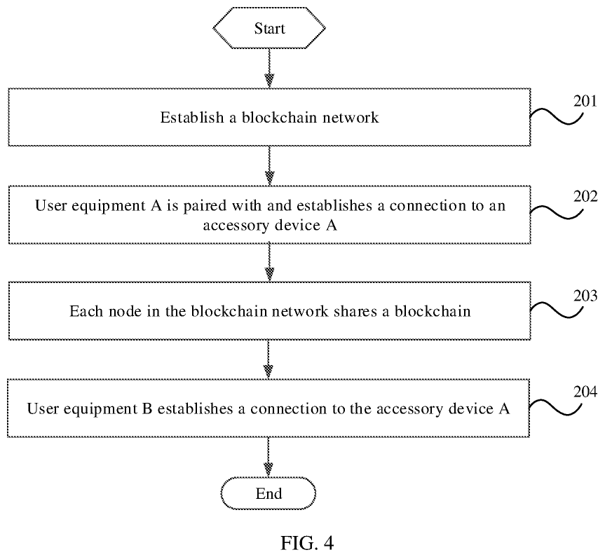

With reference to FIG. 2, FIG. 4 is a schematic flowchart of a pairing method according to an embodiment. FIG. 4 includes the following steps.

Step 201: Establish a blockchain network.

User equipment A, user equipment B, and user equipment C may each be provided with a blockchain client, to communicate with another node on a blockchain by using the client.

The user equipment A, the user equipment C, and the user equipment C may establish the blockchain network. It may be understood as that a blockchain transaction is established between the user equipment A, the user equipment B, and the user equipment C. As an initiator of the blockchain network, the user equipment A may generate a block including block data used to indicate content of the transaction. Optionally, after the user equipment B and the user equipment C join the blockchain network, the user equipment A shares the block with each node (the user equipment B and the user equipment C) on the blockchain, and after the nodes reach a consensus on the block, the block data in the block takes effect. The block data may include at least one of the following: an initiator (the user equipment A) of the transaction, a type of the transaction, and the like.

Optionally, the blockchain network may be established in two manners: In an example, the user equipment B and/or the user equipment C may send join requests to the user equipment A, to request to join a trust group. In another example, the user equipment A may send join invitations to the user equipment B and/or the user equipment C, to invite the user equipment B and/or the user equipment C to join a trust group.

Step 202: The user equipment A is paired with and establishes a connection to an accessory device A.

The accessory device may be paired with any node in the blockchain network. In an example, the user equipment A may discover the accessory device, and send a pairing request to the accessory device. In another example, the accessory device may discover any node in the blockchain network and send a pairing request to the node.

After determining to be paired with the accessory device A, the user equipment A may obtain identification information of the accessory device A. Optionally, the identification information of the accessory device may be at least one of the following: a name of the accessory device, a device number of the accessory device, and the like. The user equipment A detects whether the identification information of the accessory device A exists in one or more blocks in the blockchain network. It should be noted that, as described above, each device shares a block on the blockchain, and locally caches the blockchain and the block on the blockchain. Therefore, a process in which the user equipment A detects the block is actually detecting whether block data in a block cached in a local cache includes the identification information of the accessory device A. Optionally, if the user equipment A does not detect the identification information of the accessory device A in the block, it is determined that the accessory device A has not been paired with any node in the blockchain network, and a pairing step may continue to be performed between the user equipment A and the accessory device A. If the user equipment A detects the identification information of the accessory device A in the block, it is determined that the accessory device A has been paired with any node in the blockchain network, and a step similar to step 203 may be performed. In this embodiment, as an example for description, the accessory device A is an accessory device that has not been successfully paired with any node.

Subsequently, the user equipment generates an original pairing credential, and the user equipment and the accessory device may exchange respective encryption information such as public keys. For a specific exchanging process, refer to an existing technology.

Then, the user equipment A may send, to the accessory device A, the original pairing credential encrypted based on encryption information of the accessory device A. The accessory device A may decrypt received information based on decryption information (for example, a private key) of the accessory device A, to obtain the original pairing credential. Subsequently, the accessory device A locally caches the original pairing credential and sends a pairing response to the user equipment A, to indicate that the accessory device A has successfully received the original pairing credential. After receiving the pairing response, the user equipment A may determine that the user equipment A is successfully paired with the accessory device A, and establish a connection to the accessory device A.

Step 203: Each node in the blockchain network shares a blockchain.

In this embodiment, the user equipment A may generate a block including the identification information and the encryption information of the accessory device A and add the block to the locally stored blockchain.

In addition, the user equipment A may generate a block including a pairing credential. The pairing credential is generated after the original pairing credential is encrypted based on encryption information of each node. In other words, each node corresponds to one pairing credential. The user equipment A may obtain the encryption information of each node (namely, each piece of user equipment in the blockchain network).

In an example, a manner in which the user equipment A obtains encryption information of another piece of user equipment may be: obtaining the encryption information in a blockchain establishment process. For example, the user equipment A sends a join invitation to the user equipment B, and the join invitation is used to request the user equipment B to join the blockchain network. The user equipment B may add encryption information of the user equipment B to a returned join response. Optionally, the encryption information of the user equipment B may alternatively be carried in a join request.

In another example, a manner in which the user equipment A obtains encryption information of another piece of user equipment may alternatively be: obtaining the encryption information after the trust group is established. For example, after the blockchain network is established, the user equipment A may send an encryption information request to each node that has joined the blockchain network, to obtain encryption information of each node; and accordingly, each node may send respective encryption information to the user equipment A.

The user equipment A may separately encrypt the original pairing credential based on the encryption information of each node, to generate a pairing credential corresponding to each node. In an example, the encryption information may be a public key, and the decryption information may be a private key. The encryption information (for example, the public key) and the decryption information (for example, the private key) may be an encryption/decryption pair; in other words, information encrypted by using the private key may be decrypted by using the public key, or otherwise, information encrypted by using the public key may be decrypted by using the private key. Optionally, the encryption information and the decryption information are different; in other words, an asymmetric algorithm may be used for a key including the encryption information and a key including the decryption information. For example, for a pairing credential generated based on the encryption information of the user equipment B, only a device that holds decryption information of the user equipment B may obtain an original pairing credential after decrypting the pairing credential. In an example, the original pairing credential may be a character string, for example, a string character including an English character, a number, and/or a symbol. The pairing credential may alternatively be a character string. Different from the original pairing credential, the pairing credential is a character string obtained after the original pairing credential is encrypted based on encryption information of a node. For a specific encryption process, refer to the existing technology.

With reference to FIG. 4, the user equipment A may generate a block including the pairing credential. It should be noted that, based on a feature of the blockchain, one or more pairing credentials may be included in a same block, or may be included in different blocks.

Optionally, the block may further include but is not limited to: a pairing credential generated based on the encryption information of each node and identification information of each node. The identification information of each node may be used as an index of the pairing credential corresponding to each node.

Optionally, the block may further include but is not limited to: a pairing credential generated based on the encryption information of each node and encryption information of each node. The encryption information of each node may be used as an index of the pairing credential corresponding to each node.

It should be noted that the user equipment A may first generate a block including the pairing credential of each node, and then generate a block including the identification information and the encryption information of the accessory device A.

Step 204: The user equipment B establishes a connection to the accessory device A.

The user equipment B stores the blockchain; in other words, the user equipment B stores the identification information and the encryption information of the accessory device A and a pairing credential corresponding to the user equipment B. The user equipment B may directly establish a connection to the accessory device A without a pairing process. Details are described in the following embodiments.

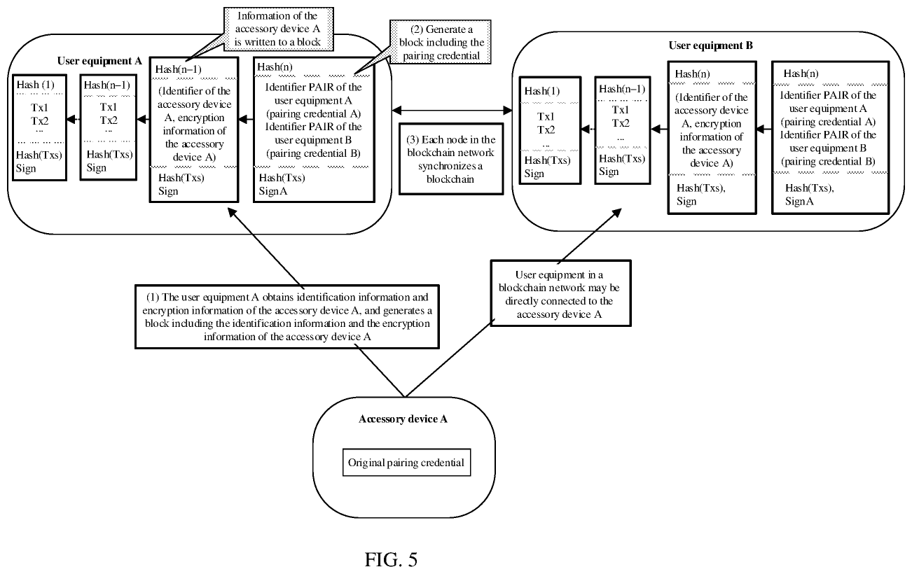

With reference to FIG. 4, a data transfer process on the blockchain is described below. In FIG. 5:

(1) The user equipment A obtains the identification information and the encryption information of the accessory device A, and generates a block including the identification information and the encryption information of the accessory device A.

After the pairing succeeds, the user equipment A may generate the block including the identification information and the encryption information of the accessory device A and add the block to a locally stored blockchain.

(2) The user equipment A generates, based on encryption information of each node in the blockchain network, a pairing credential corresponding to each node, and generates a block including the pairing credential.

(3) Each node in the blockchain network synchronizes the blockchain.

The user equipment A may synchronize, on the blockchain, newly generated blocks, namely, the block including the identification information and the encryption information of the accessory device A and the block including the pairing credential of each node to each node in the blockchain network. After the nodes reach a consensus on the new blocks, a blockchain on each node is updated; in other words, the blockchains stored on the nodes are synchronously updated. For specific details of block synchronization, refer to an existing technology.

The nodes may synchronously update the blockchains; in other words, each node stores the identification information and the encryption information of the accessory device A, and the pairing credential corresponding to each node. Then, each node may be connected to the accessory device A based on the identification information and the encryption information of the accessory device A and the pairing credential on the blockchain without a pairing process. A process for connecting another piece of user equipment to the accessory device A is described in detail in the following embodiments.

Optionally, the block on the blockchain may further record pairing information. For example, the accessory device A is successfully paired with the user equipment A, and accessory information of the accessory device A is uploaded to the blockchain by the user equipment A. Therefore, security of a pairing process is further improved.

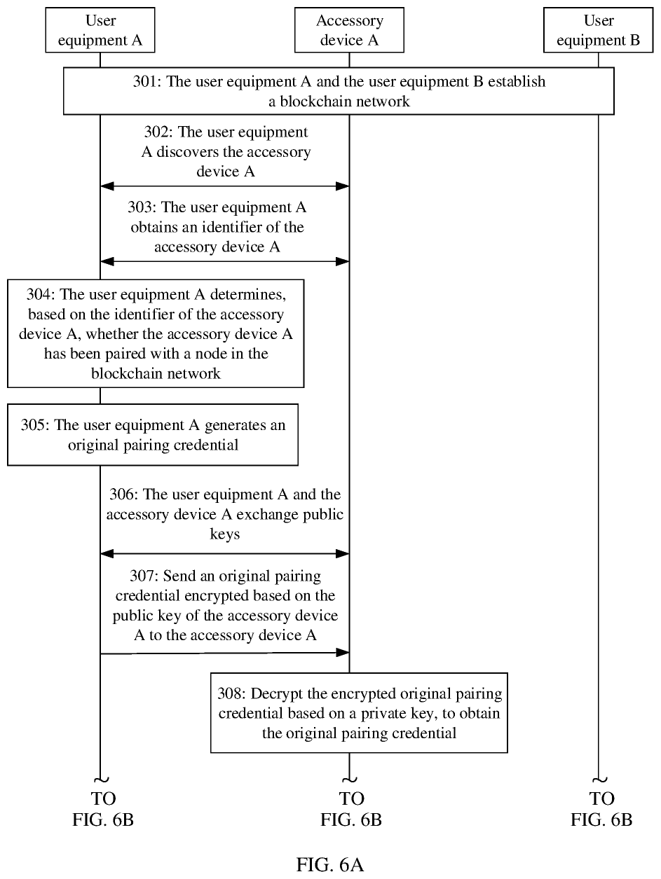

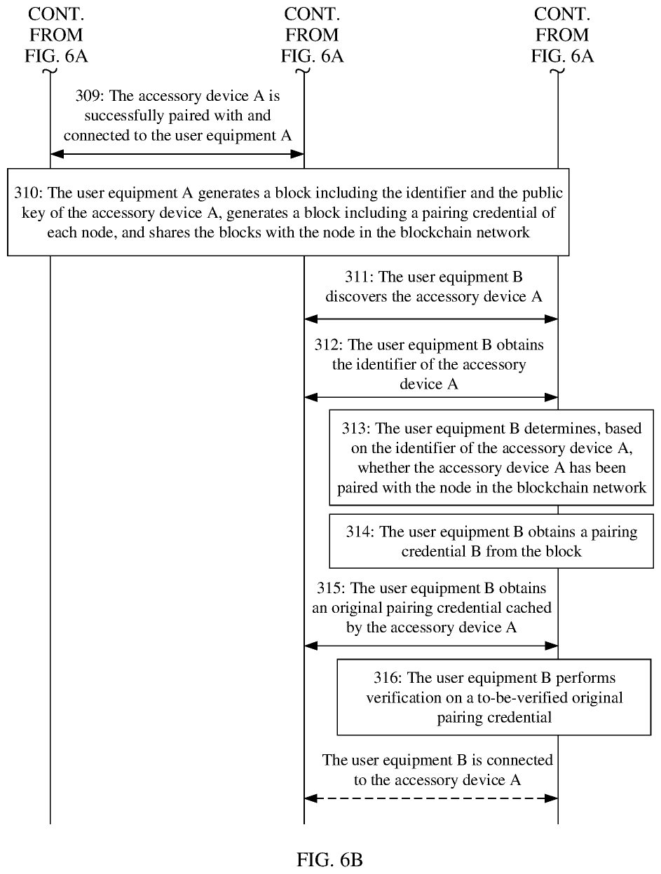

Based on the embodiment shown in FIG. 3, FIG. 6A and FIG. 6B are a schematic flowchart of a pairing method in an example. In FIG. 6A and FIG. 6B:

Step 301: User equipment A and user equipment B establish a blockchain network.

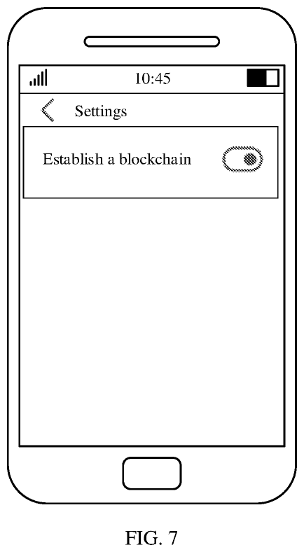

As an example for description, the user equipment A may be a mobile phone. In an example, after the mobile phone is turned on, a user may issue an instruction to the mobile phone by using a touchscreen, and a blockchain is established by using the mobile phone as a primary node. For example, in a home scenario, as shown in FIG. 7, the user sets the mobile phone as the primary node by using a setting option, to establish the blockchain network. The mobile phone may send a join invitation to another piece of user equipment such as a television set or a computer in the home scenario. For example, the user equipment B is a tablet computer. The mobile phone may invite the tablet computer to join the blockchain network.

The user equipment A and the user equipment B that have joined the blockchain network store same blockchains.

Step 302: The user equipment A discovers an accessory device A.

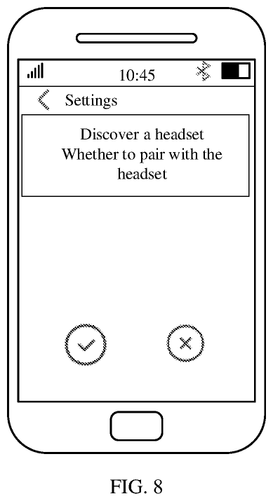

The mobile phone may discover the accessory device A by using a near-field communication method such as Bluetooth. As an example for detailed description, the accessory device A is a headset. As shown in FIG. 8, the mobile phone may scan a nearby device by using Bluetooth and discover a to-be-paired headset. The user may tap a pairing option, so that the mobile phone and the headset continue to perform following pairing steps.

Step 303: The user equipment A obtains an identifier of the accessory device A.

Step 304: The user equipment A determines, based on the identifier of the accessory device A, whether the accessory device A has been successfully paired with a node in the blockchain network.

The user equipment A may perform matching between the identifier of the accessory device A and a block in the blockchain network. If the matching succeeds, it is determined that the accessory device A has been paired with a node in the blockchain network, and a related step described in step 314 may be performed. If the matching fails, it is determined that the accessory device A has not been paired with the node in the blockchain network, and step 305 is performed.

Step 305: The user equipment A generates an original pairing credential.

Step 306: The user equipment A and the accessory device A exchange public keys.

For a specific process of exchanging the public keys, refer to an existing technology. Details are not described herein.

Step 307: The user equipment A sends an original pairing credential encrypted based on the public key of the accessory device A to the accessory device A.

Step 308: The accessory device A decrypts the encrypted original pairing credential based on a private key, to obtain the original pairing credential.

Step 309: The accessory device A is successfully paired with and connected to the user equipment A.

The accessory device A may locally cache the original pairing credential after successfully obtaining the original pairing credential. In addition, the accessory device A sends a pairing success response to the user equipment A. After receiving the response message, the user equipment A determines that pairing with the accessory device A succeeds, and establishes the connection to the accessory device A.

Step 310: The user equipment A generates a block including the identifier and the public key of the accessory device A, generates a block including a pairing credential of each node, and shares the blocks with the node in the blockchain network.

The user equipment A may obtain a public key of the user equipment B. Then, the user equipment A encrypts the original pairing credential based on the public key of the user equipment A, to generate a pairing credential A. The user equipment A encrypts the original pairing credential based on the public key of the user equipment B, to generate a pairing credential B.

Subsequently, the user equipment A generates a block A including the public key of the user equipment A, the pairing credential A, the public key of the user equipment B, and the pairing credential B. The public key of the user equipment A corresponds to (or is associated with) the pairing credential A, and the public key of the user equipment B corresponds to (or is associated with) the pairing credential B.

In addition, the user equipment A generates a block B including the identification information and the public key of the accessory device A. The user equipment A broadcasts the block A and the block B. After the user equipment A and the user equipment B reach a consensus on the block A and the block B, it is determined that block data of the block A and block data of the block B are valid.

Step 311: The user equipment B discovers the accessory device A.

Step 312: The user equipment B obtains the identifier of the accessory device A.

Step 313: The user equipment B determines, based on the identifier of the accessory device A, whether the accessory device A has been paired with the node in the blockchain network.

As described above, if the accessory device A has been successfully paired with the user equipment B, the user equipment B may match the identifier of the accessory device A on the block.

Step 314: The user equipment B obtains the pairing credential B and the public key of the accessory device A from the block.

After determining, based on the identifier of the accessory device A, that the accessory device A has been paired with the node in the blockchain network, the user equipment B may obtain the public key that is of the accessory device A and that is corresponding to the identifier of the accessory device A.

In addition, the user equipment B may query and obtain, on the block, the pairing credential corresponding to (or associated with) the public key of the user equipment B, namely, the pairing credential B.

Then, the user equipment B may decrypt the pairing credential B based on a private key of the user equipment B, to obtain the original pairing credential.

Step 315: The user equipment B obtains an original pairing credential cached by the accessory device A.

After obtaining the original pairing credential, the user equipment A may send a connection request (not shown in the figure) to the accessory device A, to request the original pairing credential cached by the accessory device A. After receiving the request, the accessory device A encrypts the cached original pairing credential based on the private key of the accessory device A, and sends the encrypted original pairing credential to the user equipment B.

The user equipment B may decrypt, based on the public key of the accessory device A, the received and encrypted original pairing credential, to obtain the original pairing credential (to be distinguished from the original pairing credential obtained from the blockchain, the original pairing credential obtained from the accessory device A is referred to as a to-be-verified original pairing credential below).

Step 316: The user equipment B performs verification on the to-be-verified original pairing credential.

Optionally, the user equipment B compares the original pairing credential with the to-be-verified original pairing credential. If the original pairing credential and the to-be-verified original pairing credential are consistent, the accessory device A is directly connected to the user equipment B. If the original pairing credential and the to-be-verified original pairing credential are inconsistent, this process ends. Optionally, if the original pairing credential and the to-be-verified original pairing credential are inconsistent, the user equipment B may further report a pairing error report, to notify the user that the accessory device A may be invaded.

Scenario 3

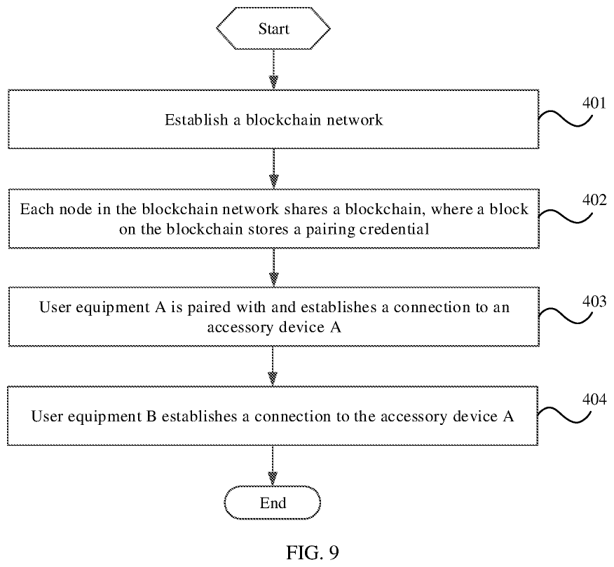

With reference to FIG. 2, FIG. 9 is a schematic flowchart of a pairing method according to an embodiment. FIG. 9 includes the following steps.

Step 401: Establish a blockchain network.

Step 402: Each node in the blockchain network shares a blockchain, where a block on the blockchain stores a pairing credential.

User equipment A may obtain encryption information of each node and generates a corresponding pairing credential based on the encryption information of each node. In addition, the user equipment A generates a block including the pairing credential corresponding to each node and synchronizes the blockchain to each node.

Step 403: The user equipment A is paired with and establishes a connection to an accessory device A.

Optionally, the accessory device needs to be paired with any node (for example, the user equipment A) in the blockchain network; in other words, the accessory device has not been paired with any node in the blockchain network. The user equipment A may search the block for a corresponding pairing credential based on identification information and/or encryption information of the user equipment A. For example, the user equipment A may match the identification information of the user equipment A with a plurality of pieces of identification information in block data of one or more blocks and obtain a pairing credential corresponding to successfully matched identification information. Then, the user equipment may decrypt the pairing credential based on decryption information of the user equipment, to obtain an original pairing credential. For example, the user equipment A may obtain the pairing credential, where the pairing credential is information encrypted based on a public key of the user equipment A, and the user equipment A may decrypt the pairing credential based on a private key of the user equipment A, to obtain the original pairing credential.

Then, the user equipment A may be paired with and establish a connection to the accessory device A based on the original pairing credential. In addition, a block that includes identification information and encryption information of the accessory device A is generated. For details, refer to Scenario 2. Details are not described herein again.

Step 404: User equipment B establishes a connection to the accessory device A.

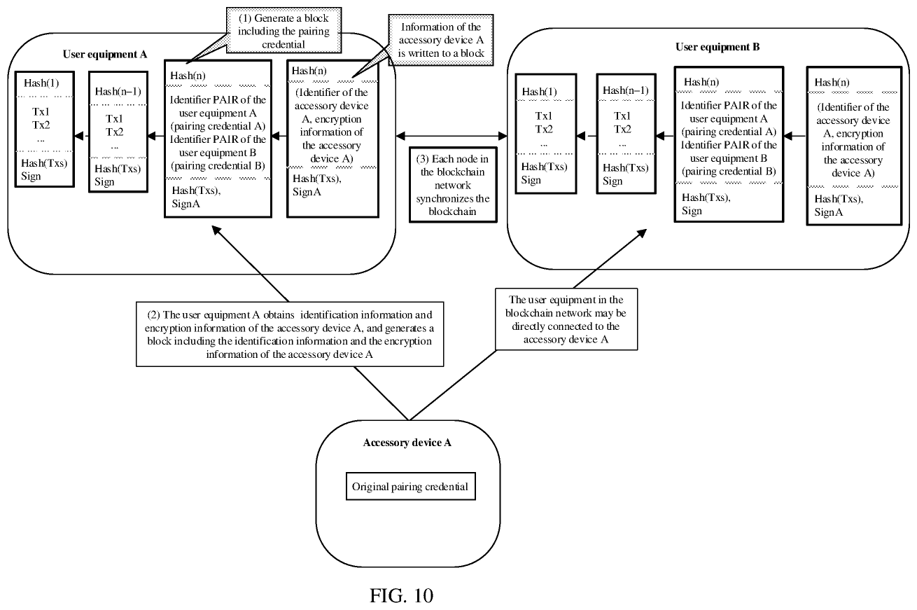

With reference to FIG. 9, a data transfer process on the blockchain is described below. In FIG. 10:

(1) The user equipment A generates, based on encryption information of each node in the blockchain network, a pairing credential corresponding to each node, and generates a block including the pairing credential.

(2) The user equipment A obtains the identification information and the encryption information of the accessory device A, and generates a block including the identification information and the encryption information of the accessory device A.

(3) Each node in the blockchain network synchronizes the blockchain.

For details, refer to Scenario 2. Details are not described herein again.

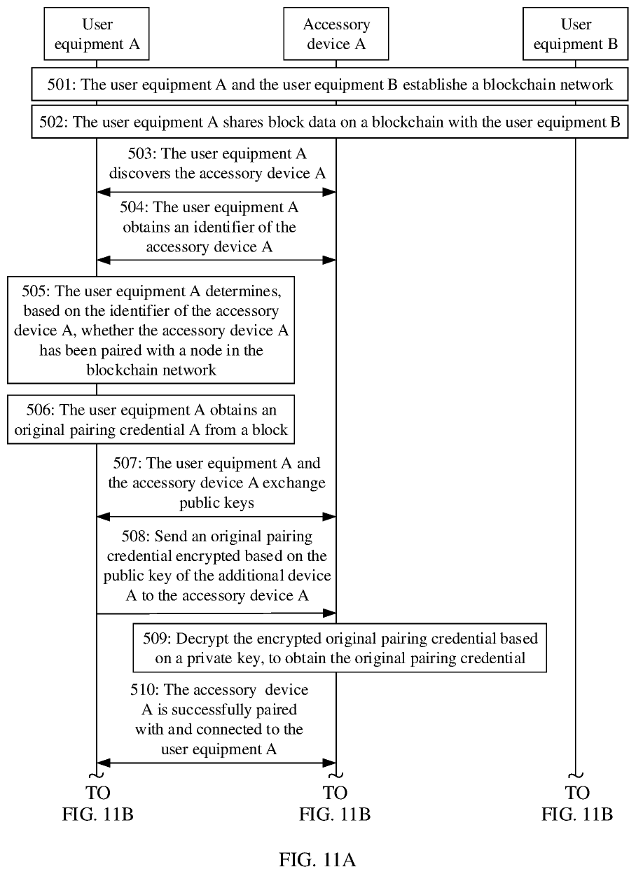

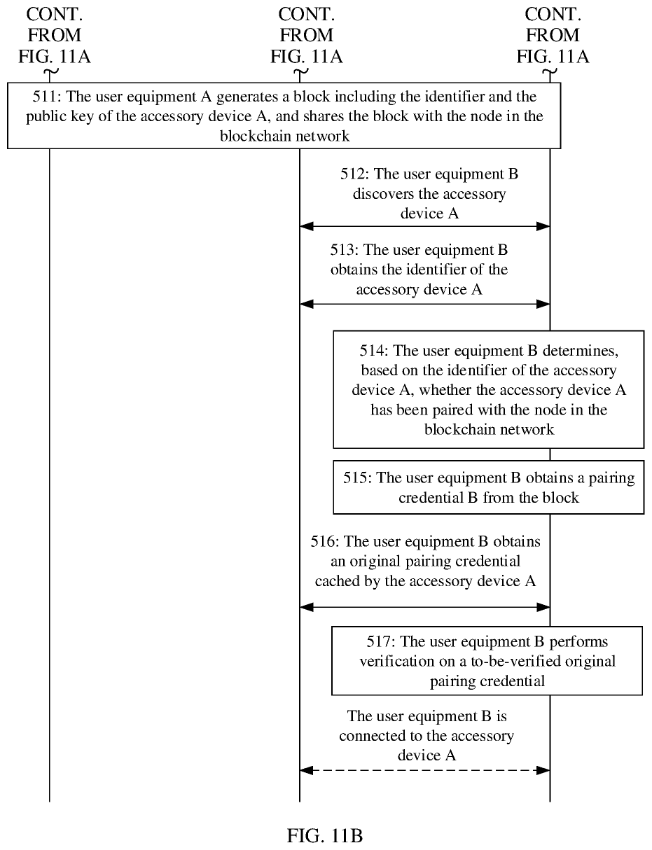

Based on the embodiment shown in FIG. 9, FIG. 11A and FIG. 11B are a schematic flowchart of a pairing method in an example. In FIG. 11A and FIG. 11B:

Step 501: User equipment A and user equipment B establish a blockchain network.

Step 502: The user equipment A and the user equipment B share block data on a blockchain.

The user equipment A may generate an original pairing credential in a process of establishing the blockchain network or after the blockchain network is successfully established, and obtain a public key of the user equipment B.

Then, the user equipment A encrypts the original pairing credential based on a public key of the user equipment A, to generate a pairing credential A. The user equipment A encrypts the original pairing credential based on the public key of the user equipment B, to generate a pairing credential B.

Subsequently, the user equipment A generates a block A including the public key of the user equipment A, the pairing credential A, the public key of the user equipment B, and the pairing credential B. The public key of the user equipment A corresponds to (or is associated with) the pairing credential A, and the public key of the user equipment B corresponds to (or is associated with) the pairing credential B.

In addition, the user equipment A broadcasts the block A. After the user equipment A and the user equipment B reach a consensus on the block A, it is determined that block data of the block A is valid.

Step 503: The user equipment A discovers an accessory device A.

Step 504: The user equipment A obtains an identifier of the accessory device A.

Step 505: The user equipment A determines, based on the identifier of the accessory device A, whether the accessory device A has been paired with a node in the blockchain network.

The user equipment A may perform matching between the identifier of the accessory device A and a block in the blockchain network. If the matching succeeds, it is determined that the accessory device A has been paired with the node in the blockchain network, and a related step described in step 515 may be performed. If the matching fails, it is determined that the accessory device A has not been paired with the node in the blockchain network, step 506 is performed.

Step 506: The user equipment A obtains an original pairing credential A from a block.

After determining that the accessory device A has not been paired with the node in the blockchain network, the user equipment A may query and obtain, on the block, the pairing credential corresponding to (or associated with) the public key of the user equipment A, namely, the pairing credential A.

Then, the user equipment A may decrypt the pairing credential A based on the private key of the user equipment A, to obtain the original pairing credential.

Step 507: The user equipment A and the accessory device A exchange public keys.

For a process of exchanging the public keys, details are not described herein.

Step 508: The user equipment A sends an original pairing credential encrypted based on a public key of the accessory device A to the accessory device A.

Step 509: The accessory device A decrypts the encrypted original pairing credential based on a private key, to obtain the original pairing credential.

Step 510: The accessory device A is successfully paired with and connected to the user equipment A.

The accessory device A locally caches the original pairing credential after successfully obtaining the original pairing credential. In addition, the accessory device A sends a pairing success response to the user equipment A. After receiving the response message, the user equipment A determines that pairing with the accessory device A succeeds, and establishes the connection to the accessory device A.

Step 511: The user equipment A generates a block including the identifier and the public key of the accessory device A and shares the block with the node in the blockchain network.

Step 512: The user equipment B discovers the accessory device A.

Step 513: The user equipment B obtains the identifier of the accessory device A.

Step 514: The user equipment B determines, based on the identifier of the accessory device A, whether the accessory device A has been paired with the node in the blockchain network.

As described above, if the accessory device A has been successfully paired with the user equipment B, the user equipment B may match the identifier of the accessory device A on the block.

Step 515: The user equipment B obtains the pairing credential B and the public key of the accessory device A from the block.

After determining, based on the identifier of the accessory device A, that the accessory device A has been paired with the node in the blockchain network, the user equipment B may obtain the public key that is of the accessory device A and that is corresponding to the identifier of the accessory device A.

In addition, the user equipment B may query and obtain, on the block, the pairing credential corresponding to (or associated with) the public key of the user equipment B, namely, the pairing credential B.

Then, the user equipment B may decrypt the pairing credential B based on a private key of the user equipment B, to obtain the original pairing credential.

Step 516: The user equipment B obtains an original pairing credential cached by the accessory device A.

After obtaining the original pairing credential, the user equipment A may send a connection request (not shown in the figure) to the accessory device A, to request the original pairing credential cached by the accessory device A. After receiving the request, the accessory device A encrypts the cached original pairing credential based on the private key of the accessory device A, and sends the encrypted original pairing credential to the user equipment B.

The user equipment B may decrypt, based on the public key of the accessory device A, the received and encrypted original pairing credential, to obtain the original pairing credential (to be distinguished from the original pairing credential obtained from the blockchain, the original pairing credential obtained from the accessory device A is referred to as a to-be-verified original pairing credential below).

Step 517: The user equipment B performs verification on the to-be-verified original pairing credential.

Optionally, the user equipment B compares the original pairing credential with the to-be-verified original pairing credential. If the original pairing credential and the to-be-verified original pairing credential are consistent, the accessory device A is directly connected to the user equipment B. If the original pairing credential and the to-be-verified original pairing credential are inconsistent, this process ends. Optionally, if the original pairing credential and the to-be-verified original pairing credential are inconsistent, the user equipment B may further report a pairing error report, to notify the user that the accessory device A may be invaded.

The foregoing describes the solutions provided in the embodiments from a perspective of interaction between network elements. It may be understood that, to implement the foregoing functions, the user equipment includes corresponding hardware structures and/or software modules for performing the functions. A person skilled in the art should be easily aware that, in combination with units and algorithm steps of the examples described in the embodiments, the embodiments may be implemented by hardware or a combination of hardware and computer software. Whether a function is performed by hardware or hardware driven by computer software depends on particular applications and constraint conditions of the solutions. A person skilled in the art may use different methods to implement the described functions, but it should not be considered that the implementation goes beyond the scope.

In the embodiments, the communication device may be divided into function modules based on the foregoing method examples. For example, each function module may be obtained through division based on a corresponding function, or two or more functions may be integrated into one processing module. The integrated module may be implemented in a form of hardware or may be implemented in a form of a software function module. It should be noted that module division in the embodiments is an example and is merely a logical function division. During actual implementation, another division manner may be used.

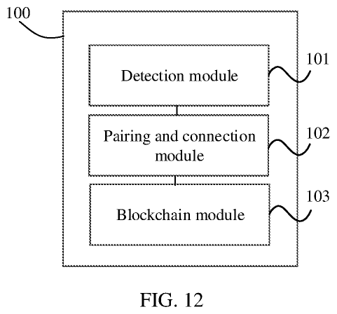

In an example, FIG. 12 is a schematic diagram of a possible structure of user equipment 100 involved in the foregoing embodiments. As shown in FIG. 12, the user equipment may include a detection module 101, a pairing and connection module 102, and a blockchain module 103. The detection module 101 may be used for a step of “detecting a second accessory device”. For example, the module may be configured to support the user equipment in performing step 102, step 202, step 302, step 403, and step 503. The pairing and connection module 102 may be used for a step of “pairing with and establishing a connection to the second accessory device based on a pairing credential”. For example, the module may be configured to support the user equipment in performing step 102, step 202, step 309, step 403, and step 510. The blockchain module 103 may be used for a step of “synchronizing identification information of the second accessory device to all user equipment in a cluster”. For example, the module may be configured to support the user equipment in performing step 102, step 203, step 310, step 403, and step 511.

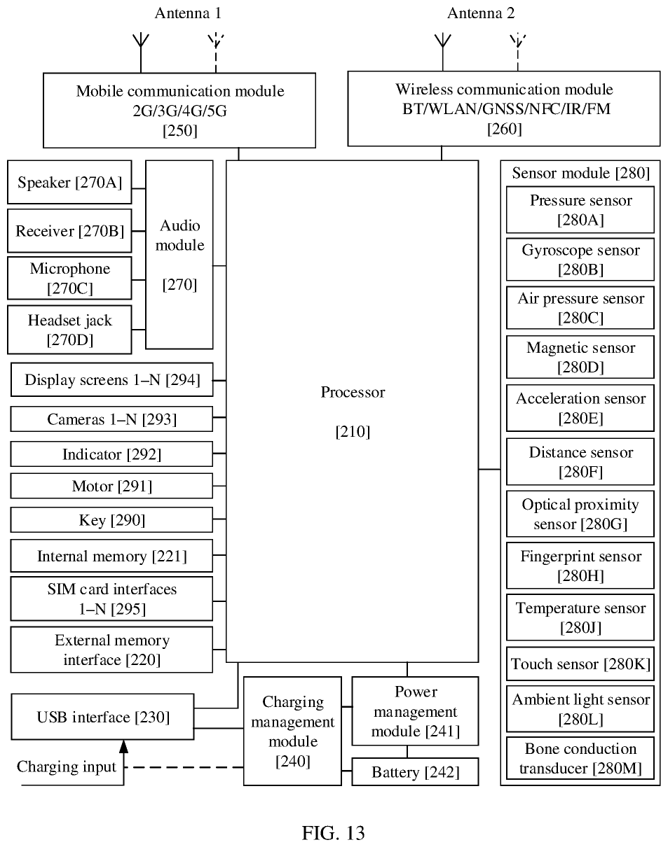

In another example, FIG. 13 is a schematic block diagram of user equipment according to an embodiment, and FIG. 13 is a schematic diagram of a structure of the user equipment when the user equipment is a mobile phone.

As shown in FIG. 13, a mobile phone 200 may include a processor 210, an external memory interface 220, an internal memory 221, a universal serial bus (USB) interface 230, a charging management module 240, a power management module 241, a battery 242, an antenna 1, an antenna 2, a mobile communication module 250, a wireless communication module 260, an audio module 270, a speaker 270A, a receiver 270B, a microphone 270C, a headset jack 270D, a sensor module 280, a button 290, a motor 291, an indicator 292, a camera 293, a display 294, a subscriber identification module (SIM) card interface 295, and the like. The sensor module 280 may include a pressure sensor 280A, a gyroscope sensor 280B, a barometric pressure sensor 280C, a magnetic sensor 280D, an acceleration sensor 280E, a distance sensor 280F, an optical proximity sensor 280G, a fingerprint sensor 280H, a temperature sensor 280J, a touch sensor 280K, an ambient light sensor 280L, a bone conduction sensor 280M, and the like.

It may be understood that a structure shown in this embodiment does not constitute a limitation on the mobile phone 200. In some other embodiments, the mobile phone 200 may include more or fewer components than those shown in the figure, combine some components, divide some components, or have different component arrangements. The components shown in the figure may be implemented by hardware, software, or a combination of software and hardware.

The processor 210 may include one or more processing units. For example, the processor 210 may include an application processor (AP), a modem processor, a graphics processing unit (GPU), an image signal processor (ISP), a controller, a video codec, a digital signal processor (DSP), a baseband processor, and/or a neural-network processing unit (NPU). Different processing units may be independent components or may be integrated into one or more processors.

The controller may generate an operation control signal based on instruction operation code and a time sequence signal, to complete control of instruction fetching and instruction execution.

A memory may be further disposed in the processor 210 and is configured to store instructions and data. In some embodiments, the memory in the processor 210 is a cache memory. The memory may store instructions or data that is just used or cyclically used by the processor 210. If the processor 210 needs to use the instructions or the data again, the processor 210 may directly call the instructions or the data from the memory. This avoids repeated access and reduces a waiting time of the processor 210. Therefore, system efficiency is improved.

In some embodiments, the processor 210 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like.

The I2C interface is a two-way synchronization serial bus and may include one serial data line (SDA) and one serial clock line (SCL). In some embodiments, the processor 210 may include a plurality of groups of I2C buses. The processor 210 may be coupled to the touch sensor 280K, a charger, a flash, the camera 293, and the like through different I2C bus interfaces. For example, the processor 210 may be coupled to the touch sensor 280K through the I2C interface, so that the processor 210 communicates with the touch sensor 280K through the I2C bus interface, to implement a touch function of the mobile phone 200.

The I2S interface may be configured to perform audio communication. In some embodiments, the processor 210 may include a plurality of groups of I2S buses. The processor 210 may be coupled to the audio module 270 through the I2S bus, to implement communication between the processor 210 and the audio module 270. In some embodiments, the audio module 270 may transfer an audio signal to the wireless communication module 260 through the I2S interface, to implement a function of answering a call by using a Bluetooth headset.

The PCM interface may also be configured to: perform audio communication, and sample, quantize, and code an analog signal. In some embodiments, the audio module 270 may be coupled to the wireless communication module 260 through a PCM bus interface. In some embodiments, the audio module 270 may alternatively transfer an audio signal to the wireless communication module 260 through the PCM interface, to implement a function of answering a call by using a Bluetooth headset. Both the I2S interface and the PCM interface may be configured to perform audio communication.

The UART interface may be a universal serial data bus configured to perform asynchronous communication. The bus may be a two-way communication bus that converts to-be-transmitted data between serial communication and parallel communication. In some embodiments, the UART interface is usually configured to connect the processor 210 and the wireless communication module 260. For example, the processor 210 communicates with a Bluetooth module in the wireless communication module 260 through the UART interface, to implement a Bluetooth function. In some embodiments, the audio module 270 may transfer an audio signal to the wireless communication module 260 through the UART interface, to implement a function of playing music by using a Bluetooth headset.

The MIPI interface may be configured to connect the processor 210 and a peripheral component such as the display 294 or the camera 293. The MIPI interface includes a camera serial interface (CSI), a display serial interface (DSI), or the like. In some embodiments, the processor 210 communicates with the camera 293 through the CSI interface, to implement a photographing function of the mobile phone 200. The processor 210 communicates with the display 294 through the DSI interface, to implement a display function of the mobile phone 200.

The GPIO interface may be configured by using software. The GPIO interface may be configured as a control signal or may be configured as a data signal. In some embodiments, the GPIO interface may be configured to connect the processor 210 to the camera 293, the display 294, the wireless communication module 260, the audio module 270, the sensor module 280, or the like. The GPIO interface may be further configured as the I2C interface, the I2S interface, the UART interface, the MIPI interface, or the like.

The USB interface 230 is an interface that conforms to a USB standard specification that may be a mini USB interface, a micro USB interface, a USB Type-C interface, or the like. The USB interface 230 may be configured to connect to a charger to charge the mobile phone 200, may be configured to transmit data between the mobile phone 200 and a peripheral device, may also be configured to connect to a headset to play audio by using the headset. The port may be further configured to connect to another mobile phone, for example, an AR device.

It may be understood that an interface connection relationship between the modules shown in this embodiment is merely an example for description and does not constitute a limitation on the structure of the mobile phone 200. In some other embodiments, the mobile phone 200 may alternatively use an interface connection manner different from that in the foregoing embodiment or use a combination of a plurality of interface connection manners.

The charging management module 240 is configured to receive charging input from the charger. The charger may be a wireless charger or a wired charger. In some embodiments of wired charging, the charging management module 240 may receive charging input of the wired charger through the USB interface 230. In some embodiments of wireless charging, the charging management module 240 may receive wireless charging input by using a wireless charging coil of the mobile phone 200. The charging management module 240 may further supply power to the mobile phone by using the power management module 241 while charging the battery 242.

The power management module 241 is configured to connect the battery 242 and the charging management module 240 to the processor 210. The power management module 241 receives input of the battery 242 and/or the charging management module 240, and supplies power to the processor 210, the internal memory 221, the display 294, the camera 293, the wireless communication module 260, and the like. The battery 242 may be further configured to monitor parameters such as a battery capacity, a quantity of battery cycles, and a battery health status (electric leakage or impedance). In some other embodiments, the power management module 241 may alternatively be disposed in the processor 210. In some other embodiments, the power management module 241 and the charging management module 240 may alternatively be disposed in a same device.

A wireless communication function of the mobile phone 200 may be implemented through the antenna 1, the antenna 2, the mobile communication module 250, the wireless communication module 260, the modem processor, the baseband processor, and the like.

The antenna 1 and the antenna 2 are configured to transmit and receive electromagnetic wave signals. Each antenna in the mobile phone 200 may be configured to cover one or more communication bands. Different antennas may be further multiplexed, to improve antenna utilization. For example, the antenna 1 may be multiplexed as a diversity antenna in a wireless local area network. In some other embodiments, the antenna may be used in combination with a tuning switch.

The mobile communication module 250 may provide a wireless communication solution that includes 2G/3G/4G/5G or the like and that is applied to the mobile phone 200. The mobile communication module 250 may include at least one filter, a switch, a power amplifier, a low noise amplifier (LNA), and the like. The mobile communication module 250 may receive an electromagnetic wave by using the antenna 1, perform processing such as filtering or amplification on the received electromagnetic wave, and transfer the electromagnetic wave to the modem processor for demodulation. The mobile communication module 250 may further amplify a signal modulated by the modem processor and convert the signal into an electromagnetic wave for radiation through the antenna 1. In some embodiments, at least some function modules in the mobile communication module 250 may be disposed in the processor 210. In some embodiments, at least some function modules in the mobile communication module 250 may be disposed in a same device as at least some modules in the processor 210.

The modem processor may include a modulator and a demodulator. The modulator is configured to modulate a to-be-sent low frequency baseband signal into a medium and high frequency signal. The demodulator is configured to demodulate a received electromagnetic wave signal into a low frequency baseband signal. Then, the demodulator transmits the low frequency baseband signal obtained through demodulation to the baseband processor for processing. The baseband processor processes the low-frequency baseband signal, and then transfers a processed signal to the application processor. The application processor outputs a sound signal by using an audio device (not limited to the speaker 270A, the receiver 270B, or the like), or displays an image or a video by using the display 294. In some embodiments, the modem processor may be an independent device. In some other embodiments, the modem processor may be independent of the processor 210 and is disposed in a same device as the mobile communication module 250 or another function module.

The wireless communication module 260 may provide a wireless communication solution that includes a wireless local area network (WLAN) (for example, a wireless fidelity (Wi-Fi) network), Bluetooth (BT), a global navigation satellite system (GNSS), frequency modulation (FM), a near field communication (NFC) technology, an infrared (IR) technology, or the like and that is applied to the mobile phone 200. The wireless communication module 260 may be one or more devices that integrate at least one communication processing module. The wireless communication module 260 receives an electromagnetic wave through the antenna 2, performs frequency modulation and filtering processing on an electromagnetic wave signal, and sends a processed signal to the processor 210. The wireless communication module 260 may further receive a to-be-sent signal from the processor 210, perform frequency modulation and amplification on the signal, and convert the signal into an electromagnetic wave for radiation through the antenna 2.

In some embodiments, in the mobile phone 200, the antenna 1 and the mobile communication module 250 are coupled, and the antenna 2 and the wireless communication module 260 are coupled, so that the mobile phone 200 can communicate with a network and another device by using a wireless communication technology. The wireless communication technology may include a global system for mobile communication (GSM), a general packet radio service (GPRS), code division multiple access (CDMA), wideband code division multiple access (WCDMA), time-division code division multiple access (TD-SCDMA), long term evolution (LTE), BT, a GNSS, a WLAN, NFC, FM, the IR technology, and/or the like. The GNSS may include a global positioning system (GPS), a global navigation satellite system (GLONASS), a beidou navigation satellite system (BDS), a quasi-zenith satellite system (QZSS), and/or a satellite based augmentation system (SBAS).

The mobile phone 200 implements a display function by using the GPU, the display 294, the application processor, and the like. The GPU is a microprocessor for image processing and is connected to the display 294 and the application processor. The GPU is configured to perform mathematical and geometric calculation and render an image. The processor 210 may include one or more GPUs that execute program instructions to generate or change display information.

The display 294 is configured to display an image, a video, and the like. The display 294 includes a display panel. The display panel may be a liquid crystal display (LCD), an organic light-emitting diode (OLED), an active-matrix organic light emitting diode (AMOLED), a flex light-emitting diode (FLED), a mini LED, a micro LED, a micro-OLED, quantum dot light emitting diodes (QLED), or the like. In some embodiments, the mobile phone 200 may include one or N displays 294, where N is a positive integer greater than 1.

The mobile phone 200 can implement a photographing function by using the ISP, the camera 293, the video codec, the GPU, the display 294, the application processor, and the like.

The ISP is configured to process data fed back by the camera 293. For example, during photographing, a shutter is pressed, light is transmitted to a photosensitive element of the camera through a lens, an optical signal is converted into an electrical signal, and the photosensitive element of the camera transmits the electrical signal to the ISP for processing, to convert the electrical signal into a visible image. The ISP may further perform algorithm optimization on noise, brightness, and complexion of the image. The ISP may further optimize parameters such as exposure and a color temperature of a photographing scenario. In some embodiments, the ISP may be disposed in the camera 293.

The camera 293 is configured to capture a static image or a video. An optical image of an object is generated through the lens and is projected onto the photosensitive element. The photosensitive element may be a charge coupled device (CCD) or a complementary metal-oxide-semiconductor (CMOS) phototransistor. The photosensitive element converts an optical signal into an electrical signal, and then transmits the electrical signal to the ISP for converting the electrical signal into a digital image signal. The ISP outputs the digital image signal to the DSP for processing. The DSP converts the digital image signal into an image signal in a standard format such as RGB or YUV. In some embodiments, the mobile phone 200 may include one or N cameras 293, where N is a positive integer greater than 1.

The digital signal processor is configured to process a digital signal and may process another digital signal in addition to the digital image signal. For example, when the mobile phone 200 selects a frequency, the digital signal processor is configured to perform Fourier transform on frequency energy, and the like.

The video codec is configured to compress or decompress a digital video. The mobile phone 200 may support one or more video codecs. In this way, the mobile phone 200 can play or record videos in a plurality of coding formats, for example, moving picture experts group (MPEG)-1, MPEG-2, MPEG-3, and MPEG-4.

The NPU is a neural network (NN) computing processor that rapidly processes input information by referring to a structure of a biological neural network, for example, by referring to a transfer mode between human brain neurons and can further perform self-learning continuously. Applications such as intelligent cognition of the mobile phone 200, such as image recognition, facial recognition, voice recognition, and text understanding, can be implemented by using the NPU.

The external memory interface 220 may be configured to connect to an external storage card, for example, a micro SD card, to extend a storage capability of the mobile phone 200. The external storage card communicates with the processor 210 through the external memory interface 220, to implement a data storage function. For example, files such as music and videos are stored in the external storage card.

The internal memory 221 may be configured to store computer-executable program code. The executable program code includes instructions. The internal memory 221 may include a program storage area and a data storage area. The program storage area may store an operating system, an application required by at least one function (for example, a sound playing function or an image playing function), and the like. The data storage area may store data (for example, audio data or an address book) created during use of the mobile phone 200, and the like. In addition, the internal memory 221 may include a high-speed random access memory or may include a nonvolatile memory such as at least one magnetic disk storage device, a flash memory, or a universal flash storage (UFS). The processor 210 runs the instructions stored in the internal memory 221 and/or the instructions stored in the memory disposed in the processor, to execute various function applications of the mobile phone 200 and data processing.

The mobile phone 200 may implement an audio function, for example, music playback or recording through the audio module 270, the speaker 270A, the receiver 270B, the microphone 270C, the headset jack 270D, the application processor, and the like.

The audio module 270 is configured to convert digital audio information into an analog audio signal for output and is also configured to convert analog audio input into a digital audio signal. The audio module 270 may be further configured to encode and decode an audio signal. In some embodiments, the audio module 270 may be disposed in the processor 210, or some function modules in the audio module 270 are disposed in the processor 210.

The speaker 270A, also referred to as a “horn”, is configured to convert an audio electrical signal into a sound signal. The mobile phone 200 may listen to music or answer a hands-free call by using the speaker 270A.

The receiver 270B, also referred to as an “earpiece”, is configured to convert an audio electrical signal into a sound signal. When a call is answered or voice information is received by using the mobile phone 200, the receiver 270B may be put close to a human ear to listen to a voice.

The microphone 270C, also referred to as a “mike” or a “microphone”, is configured to convert a sound signal into an electrical signal. When making a call or sending voice information, a user may make a sound close to the microphone 270C through a mouth of the user, to input a sound signal to the microphone 270C. At least one microphone 270C may be disposed in the mobile phone 200. In some other embodiments, two microphones 270C may be disposed in the mobile phone 200, to collect a sound signal and further implement a noise reduction function. In some other embodiments, three, four, or more microphones 270C may alternatively be disposed in the mobile phone 200, to collect a sound signal, reduce noise, further identify a sound source, implement a directional recording function, and the like.

The headset jack 270D is configured to be connect to a wired headset. The headset jack 270D may be a USB interface 230, a 3.5 mm open mobile terminal platform (OMTP) standard interface, or a cellular telecommunication industry association of the USA (CTIA) standard interface.

The pressure sensor 280A is configured to sense a pressure signal and can convert the pressure signal into an electrical signal. In some embodiments, the pressure sensor 280A may be disposed on the display 294. There are many types of pressure sensors 280A such as a resistive pressure sensor, an inductive pressure sensor, and a capacitive pressure sensor. The capacitive pressure sensor may include at least two parallel plates made of conductive materials.

The gyro sensor 280B may be configured to determine a moving posture of the mobile phone 200.

The barometric pressure sensor 280C is configured to measure atmospheric pressure.

The magnetic sensor 280D includes a Hall sensor.

The acceleration sensor 280E may detect of accelerations in various directions (usually on three axes) of the mobile phone 200.

The range sensor 280F is configured to measure a distance.

For example, the optical proximity sensor 280G may include a light-emitting diode (LED) and an optical detector, for example, a photodiode. The light-emitting diode may be an infrared light-emitting diode.

The ambient light sensor 280L is configured to sense ambient light brightness.

The fingerprint sensor 280H is configured to collect a fingerprint.

The temperature sensor 280J is configured to detect a temperature.

The touch sensor 280K is also referred to as a “touch control device”. The touch sensor 280K may be disposed on the display 294. The touch sensor 280K and the display 294 form a touchscreen, which is also referred to as a “touchscreen”. The touch sensor 280K is configured to detect a touch operation performed on or near the touch sensor 280K. The touch sensor may transfer the detected touch operation to the application processor, to determine a type of a touch event. The display 294 may provide a visual output related to the touch operation. In some other embodiments, the touch sensor 280K may alternatively be disposed on a surface of the mobile phone 200 at a location different from that of the display 294.

The bone conduction sensor 280M may obtain a vibration signal.

The button 290 includes a power button, a volume button, and the like. The button 290 may be a mechanical button or may be a touch button. The mobile phone 200 may receive button input and generate button signal input related to a user setting and function control of the mobile phone 200.

The motor 291 may generate a vibration prompt. The motor 291 may be configured to provide an incoming call vibration prompt or may be configured to provide touch vibration feedback.

The indicator 292 may be an indicator light, may be configured to indicate a charging status and a power change, or may be configured to indicate a message, a missed call, a notification, and the like.

The SIM card interface 295 is configured to connect to a SIM card. A SIM card may be inserted into the SIM card interface 295 or removed from the SIM card interface 295, to implement contact with or separation from the mobile phone 200. The mobile phone 200 may support one or N SIM card interfaces, where N is a positive integer greater than 1. The SIM card interface 295 may support a nano SIM card, a micro SIM card, a SIM card, and the like. The mobile phone 200 interacts with a network by using the SIM card, to implement functions such as calling and data communication. In some embodiments, the mobile phone 200 may use an embedded SIM card (eSIM). The eSIM card may be embedded in the mobile phone 200 and cannot be separated from the mobile phone 200.

An embodiment may further provide a non-transitory computer-readable storage medium. The non-transitory computer-readable storage medium stores a computer program, the computer program includes at least one segment of code, and the at least one segment of code may be executed by a network device, to control the network device to implement the foregoing method embodiments.

An embodiment may further provide a computer program. When the computer program is executed by a network device, the computer program is used to implement the foregoing method embodiment.

The program may be all or partially stored in a storage medium that is encapsulated with a processor or may be all or partially stored in a memory that is not encapsulated with a processor.

An embodiment may further provide a processor. The processor is configured to implement the foregoing method embodiments. The processor may be a chip.

Methods or algorithm steps described with reference to the content in the embodiments may be implemented by hardware or may be implemented by a processor by executing software instructions. The software instructions may include a corresponding software module. The software module may be stored in a random access memory (RAM), a flash memory, a read only memory (ROM), an erasable programmable read only memory (EPROM), an electrically erasable programmable read only memory (EEPROM), a register, a hard disk, a removable hard disk, a compact disc read-only memory (CD-ROM), or any other form of storage medium well-known in the art. For example, a storage medium is coupled to a processor, so that the processor can read information from the storage medium or write information into the storage medium. Further, the storage medium may be a component of the processor. The processor and the storage medium may be located in an ASIC. In addition, the ASIC may be located in the network device. Also, the processor and the storage medium may exist in the network device as discrete components.

A person skilled in the art should be aware that in the foregoing one or more examples, functions described in the embodiments may be implemented by hardware, software, firmware, or any combination thereof. When implemented by software, the foregoing functions may be stored in a non-transitory computer-readable medium. The computer-readable medium includes a computer storage medium and a communication medium. The storage medium may be any available medium accessible to a general-purpose or special-purpose computer.

The foregoing describes the embodiments with reference to the accompanying drawings, but the embodiments are not limited to the foregoing implementations. The foregoing implementations are merely examples and are not limitative. A person of ordinary skill in the art may further make many modifications without departing from the scope of the embodiments.

1. A pairing method, applied to first user equipment, wherein the first user equipment belongs to a cluster comprising at least two pieces of user equipment, each piece of user equipment in the cluster stores first information, and the first information comprises a pairing credential and identification information of a first accessory device that has been successfully paired with any piece of user equipment in the cluster and the method comprises:
detecting a second accessory device, wherein the second accessory device is an accessory device that has not been successfully paired with any piece of user equipment in the cluster; and
pairing with and establishing a connection to the second accessory device based on the pairing credential; and
synchronizing identification information of the second accessory device to all user equipment in the cluster.

2. The pairing method according to claim 1, wherein the cluster is a blockchain network, each piece of user equipment in the blockchain network stores a blockchain, a block on the blockchain stores the pairing credential and the identification information of the first accessory device, and synchronizing the identification information of the second accessory device to all user equipment in the cluster further comprises:
generating a new block comprising the identification information of the second accessory device; and
adding the new block to a blockchain on the first user equipment; and
synchronizing the new block to a blockchain on another piece of user equipment in the blockchain network.

3. The pairing method according to claim 2, wherein the pairing credential is generated after an original pairing credential is encrypted based on encryption information of the first user equipment; and the original pairing credential is generated by user equipment that establishes the blockchain network; or the original pairing credential is generated by any piece of user equipment in the blockchain network.

4. The pairing method according to claim 3, wherein pairing with and establishing the connection to the second accessory device based on the pairing credential further comprises:
obtaining the pairing credential from the blockchain on the first user equipment;
decrypting the pairing credential based on decryption information of the first user equipment, to obtain the original pairing credential; and
sending the original pairing credential to the second accessory device;
determining, after a pairing response message of the second accessory device is received, that pairing with the second accessory device succeeds; and
establishing the connection to the second accessory device.

5. The pairing method according to claim 4, wherein the encryption information of the first user equipment and the decryption information of the first user equipment are different.

6. The pairing method according to claim 4, wherein the block on the blockchain further stores encryption information of the first accessory device, and synchronizing the identification information of the second accessory device to all user equipment in the cluster further comprises:
generating a new block comprising the identification information of the second accessory device and encryption information of the second accessory device;
adding the new block to the blockchain on the first user equipment; and
synchronizing the new block to a blockchain on another piece of user equipment in the blockchain network.

7. A pairing apparatus, applied to a first user equipment, wherein the first user equipment belongs to a cluster comprising at least two pieces of user equipment, each piece of user equipment in the cluster stores first information, and the first information comprises a pairing credential and identification information of a first accessory device that has been successfully paired with any piece of user equipment in the cluster, and the apparatus comprises:
a memory; and
a processor, wherein the memory is coupled to the processor, the memory stores program instructions, and, when the program instructions are run by the processor, the apparatus is configured to perform the following steps:
detecting a second accessory device, wherein the second accessory device is an accessory device that has not been successfully paired with any piece of user equipment in the cluster;
pairing with and establishing a connection to the second accessory device based on the pairing credential; and
synchronizing identification information of the second accessory device to all user equipment in the cluster.

8. The pairing apparatus according to claim 7, wherein the cluster is a blockchain network, each piece of user equipment in the blockchain network stores a blockchain, a block on the blockchain stores the pairing credential and identification information of the first accessory device, and when the program instructions are run by the processor, the apparatus is further configured to perform the following steps:
generating a new block comprising the identification information of the second accessory device;
adding the new block to a blockchain on the first user equipment; and
synchronizing the new block to a blockchain on another piece of user equipment in the blockchain network.

9. The pairing apparatus according to claim 8, wherein the pairing credential is generated after an original pairing credential is encrypted based on encryption information of the first user equipment; and the original pairing credential is generated by user equipment that establishes the blockchain network; or the original pairing credential is generated by any piece of user equipment in the blockchain network.

10. The pairing apparatus according to claim 9, wherein when the program instructions are run by the processor, the apparatus is further configured to perform the following steps:
obtaining the pairing credential from the blockchain on the first user equipment;
decrypting the pairing credential based on decryption information of the first user equipment, to obtain the original pairing credential;
sending the original pairing credential to the second accessory device;
determining, after a pairing response message of the second accessory device is received, that pairing with the second accessory device succeeds; and
establishing the connection to the second accessory device.

11. The pairing apparatus according to claim 10, wherein the encryption information of the first user equipment and the decryption information of the first user equipment are different.

12. The pairing apparatus according to claim 11, wherein the block on the blockchain further stores encryption information of the first accessory device; and when the program instructions are run by the processor, the apparatus is further configured to perform the following steps:
generating a new block comprising the identification information of the second accessory device and encryption information of the second accessory device;
adding the new block to the blockchain on the first user equipment; and
synchronizing the new block to a blockchain on another piece of user equipment in the blockchain network.

13. A non-transitory computer-readable storage medium, wherein the computer-readable storage medium applied to a first user equipment, wherein the first user equipment belongs to a cluster comprising at least two pieces of user equipment, each piece of user equipment in the cluster stores first information, and the first information comprises a pairing credential and identification information of a first accessory device that has been successfully paired with any piece of user equipment in the cluster, storing one or more instructions for scheduling a task processing that, when executed by at least one processor, cause the at least one processor to:
detect a second accessory device, wherein the second accessory device is an accessory device that has not been successfully paired with any piece of user equipment in the cluster;
pair with and establishing a connection to the second accessory device based on the pairing credential; and
synchronize identification information of the second accessory device to all user equipment in the cluster.

14. The non-transitory computer-readable storage medium according to claim 13, wherein the cluster is a blockchain network, each piece of user equipment in the blockchain network stores a blockchain, a block on the blockchain stores the pairing credential and identification information of the first accessory device, and when the program instructions are run by the processor, wherein one or more instructions, when executed by the at least one processor, further cause the at least one processor to: generate a new block comprising the identification information of the second accessory device, and adding the new block to a blockchain on the first user equipment; and
synchronize the new block to a blockchain on another piece of user equipment in the blockchain network.

15. The non-transitory computer-readable storage medium according to claim 14, wherein the pairing credential is generated after an original pairing credential is encrypted based on encryption information of the first user equipment; and the original pairing credential is generated by user equipment that establishes the blockchain network; or the original pairing credential is generated by any piece of user equipment in the blockchain network.

16. The non-transitory computer-readable storage medium according to claim 15, wherein one or more instructions, when executed by the at least one processor, further cause the at least one processor to:
obtain the pairing credential from the blockchain on the first user equipment;
decrypt the pairing credential based on decryption information of the first user equipment, to obtain the original pairing credential;
send the original pairing credential to the second accessory device;
determine, after a pairing response message of the second accessory device is received, that pairing with the second accessory device succeeds; and
establishing the connection to the second accessory device.

17. The non-transitory computer-readable storage medium according to claim 16, wherein the encryption information of the first user equipment and the decryption information of the first user equipment are different.

18. The non-transitory computer-readable storage medium according to claim 16, wherein the block on the blockchain further stores encryption information of the first accessory device; and wherein one or more instructions, when executed by the at least one processor, further cause the at least one processor to:
generate a new block comprising the identification information of the second accessory device and encryption information of the second accessory device;
add the new block to the blockchain on the first user equipment; and
synchronize the new block to a blockchain on another piece of user equipment in the blockchain network.
